(19) United States
(12) Patent Application Publication
(10) Pub. No.: US 2013/0110576 A1
(43) Pub. Date: May 2, 2013

(54) SYSTEM AND METHOD FOR CHECKING THE CONFORMANCE OF THE BEHAVIOR OF A PROCESS

(71) Applicants: Suman Roy, Kolkata (IN); Sidharth Shankar Bihary, Berhampur (IN); Maneesh Khattri, Kathmandu (NP)

(72) Inventors: Suman Roy, Kolkata (IN); Sidharth Shankar Bihary, Berhampur (IN); Maneesh Khattri, Kathmandu (NP)

(73) Assignee: INFOSYS LIMITED, Bangalore (IN)

(21) Appl. No.: 13/418,316

(22) Filed: Mar. 12, 2012

(30) Foreign Application Priority Data
Oct. 28, 2011 (IN) 3698/CHE/2011

(51) Int. Cl. G06Q 10/06

(52) U.S. Cl. 705/7.26

(57) ABSTRACT

A method and apparatus for checking the fit of behaviour of a business process and observed behaviour of the system in terms of event logs. The method includes generating a behaviorally equivalent CSP description of the business process and trace equivalent CSP description of event logs. Further the generation of CSP processes for a business process includes segregating a business process model into a set of workflow patterns with connectivity between the workflow patterns, generating a CSP process corresponding to each workflow pattern, composing the CSP processes in parallel with connectivity between the CSP processes, and synchronizing the CSP processes on common activities of the CSP processes. Lastly the generation of a CSP description of the event log is performed by constructing a CSP process for each trace in the event log and combining the CSP descriptions using external choice operator.

### RELATED APPLICATION DATA

This application claims priority to Indian Patent Application No. 3698/CHE/2011, filed Oct. 28, 2011, which is hereby incorporated by reference in its entirety.

### BACKGROUND

Process-aware information systems, such as workflow management systems, are widely used in business management as they provide a precise description of business processes. For example, auditing can be performed by process aware information systems. Auditing been made mandatory in the U.S. by legislation such as the Sarbanes-Oxlay (SOX) Act. Business activities need to be monitored for auditing an organization in conjunction with business process modeling and simulation.

Invariably, process-aware information systems use process models of some kind, such as Petri Nets, EPCs, BPMN, UML activity diagrams, etc. These process models can predict the behavior of systems. This calls for simultaneously tackling two problems, that of modeling a process and monitoring a process. Determining how closely the monitored observations follow or fit the process demonstrates the problem of “conformance”, which refers to a level of match between the recorded events and the business model. In other words, it determines how closely the event logs do match/fit the reference business process model. Determining conformance is more commonly known as “process conformance checking”.

Many information system, such as WFM, ERP, CRM, SCM, and B2B systems, maintain some kind of event logs (also called transaction logs, audit trails, and the like). A process event log is represented by a set of trace/event sequences. Such event logs, usually register the start and/or completion of activities. Moreover, each event refers to a case (process instance), an activity, and some additional data.

A process log conforms to a process model if the process can replay each trace or event sequence in the log, i.e., the set of traces of the log is included in the set of traces for the process. One way to check conformance of a process is to enumerate all finite traces (unraveling a loop only finite number of times if one such is present) in the process, and then carry out membership testing for each of the trace in the log. This checking takes quadratic time in terms of a maximum length of the traces. However, the number of possible sequences generated by a process model may grow exponentially, in particular for a model showing concurrent behavior. Hence, it is often quite resource intensive, and thus expensive, to accomplish conformance testing.

### BRIEF DESCRIPTION OF THE DRAWINGS

Embodiments of this invention will be described in detail, with reference to the attached drawings in which:

FIG. 1 is a flowchart of a method for mapping a BPM to CSP.

FIG. 2 shows a structured process P which is described using CSP.

FIG. 3 is a case study process used to illustrate the usefulness of metrics.

FIG. 4 is a block diagram of a computing device that can be used to accomplish the methods of the disclosed embodiments.

While systems, methods, and computer-readable media are described herein by way of examples and embodiments, those skilled in the art recognize that the invention is not limited to the embodiments or drawings described. Rather, the intent is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Embodiments, for example, disclose ways to address conformance checking using concepts from Communicating Sequential Processes (CSP), which facilitates automated analysis using the FDR model checker (a refinement checker establishing properties of models expressed in CSP). An arbitrary process log (finite collection of event logs) is used to create a simple trace-equivalent CSP process using prefix and external choice operators. This is called implementation. The problem also assumes the existence of a structured BPM process as a reference model. This is also translated to a CSP description using a pattern-oriented approach, in which this CSP model is referred to peas a specification. Finally, both models are fed into the FDR model checker, and it is determined if the implementation trace refines the specification. Metrics can be provided based on conformance checking, related to fitness, closeness, and appropriateness of the event logs with the reference process models.

A business process flow must be properly modeled before being implemented as work flows. Using control elements such as and-splits, and-joins, or-splits, and or-joins various activities can be coordinated in a work flow. In a structured process, each split control element (e.g., and, or) is matched with a join control element of the same type. Further such split-join pairs are also properly nested. Of course, not all process models are structured. In fact, unstructured processes are widely used since they are more expressive. There are practical systems which allow for specification of structured processes only, e.g., SAP R/3, Filenet Visual and Workflo. Only structured processes are explicitly discussed herein as reference models for conformance checking. However, many unstructured processes can be converted to structured models preserving trace equivalence.

Communicating Sequential Processes (CSP) is a formal language for describing patterns of interaction in concurrent systems. It is a member of the family of mathematical theories of concurrency known as process algebras, or process calculi. CSP has been practically applied in industry as a tool for specifying and verifying the concurrent aspects of a variety of different systems. The advantage gained by using CSP models are that they can be readily fed into the FDR model checker for automated analyses, such as refinement checking. The conformance checking problem is equivalent to trace refinement checking between the generated CSP processes.

Process logs are translated to trace-equivalent CSP processes using prefix and external choice operators. A structured reference BPM process is also mapped to an appropriate CSP process preserving traces. These CSP processes are fed into the FDR model checker for conformance checking. This technique is implemented on top of the FDR model checker. The compositional nature of structured processes allow them to be mapped easily to CSP descriptions. Moreover, using the FDR model checker, it is possible to list all the error traces in the log. Using this information metrics are defined related to fitness, closeness, and appropriateness, in accordance with the requirement of conformance checking.

With respect to the process log, let T be the set of log events (here they are also called tasks/activities). A trace is denoted as σεT*, where σ=t₀, t₁, . . . tₙ₋₁, such that t₁εT, 0≦i≦n−1. The length of the trace is denoted as |σ|=n, and let σ₁ to be the ith element of the trace. A process log, denoted as WεP(T*), is defined as a set of traces.

The Business Process Management Initiative (BPMI) has come out with a standard Business Process Modeling Notation (BPMN) for capturing pictorial representation of business processes, which is widely adopted by the industries for use in the early phases of systems development. BPMN defines a Business Process Diagram (BPD) (also called BPM process P) which is based on flowchart related ideas, and provides a graphical notation for business process modeling using objects like nodes, edges etc.

The control flow relation links two nodes in the graph showing the proper execution order in a BPD. A node can be a task (also called an activity), an event or a choice/merge gateway. An activity refers to the work required to achieve an objective. In a BPD, there are start events denoting the beginning of a process, and end events denoting the end of a process. In a flow graph the control flow relation linking two nodes is represented by a directed edge capturing the execution order between tasks of a BPD. A sequence is made of a node that has an incoming and an outgoing arc.

A choice/merge gateway or connector is a routine construct to control the separation/merge of control flows. It is represented by diamond. A fork (AND-split) node separates two concurrent paths and allows independent execution between concurrent paths within a BPD. It is modeled by connecting two or more outgoing control flow relations to a task. For synchronizing concurrent paths, a synchronizer (AND-join) is used so that it can link all the incoming edges to it. A synchronizer delays its completion until all incoming control flow relations leading into the task complete their execution. From a choice (XOR-split) node, two or more outgoing control flow relations diverge resulting in mutually exclusive alternative paths. This forces one to select only one alternative outgoing control flow relation at run-time. A merge (XOR-join) node is the counterpart of the choice node and connects incoming mutually exclusive alternative paths into one path.

A BPM process is well-formed if and only if 1) it has exactly one start node with no incoming edges and one outgoing edge from it, 2) it has exactly one end node with one incoming edge to it and no outgoing edges, 3) there is only one incoming edge to a task and exactly one outgoing edge to a task, 4) each fork and choice has exactly one incoming edge and at least two outgoing edges, 5) each synchronizer and merge has at least two incoming edges and exactly one outgoing edge, 6) every node is on a path from the start node to some end node, and 7) there exists at least one task in any path from a split element to a join element (this is to avoid triviality). Moreover, a well-formed BPM process is consistent if the underlying control flow graph is a directed acyclic graph, i.e, it does not contain any strongly connected component. Unless otherwise mentioned, from now on, we shall consider only consistent BPM processes.

The semantics of control elements of a BPM process are similar to that of work-flows. For a split-parallel element (fork), all the outgoing branches can be executed concurrently. Moreover, a join-parallel element (synchronizer) can be executed only when all of its incoming branches have been executed. Let us assume a split-choice (choice) element to have the semantics of an exclusive choice, i.e., all branches of a split-choice are exclusive and only one branch can be executed at one time. A combination of split parallel and exclusive choice simulate the operation of an inclusive choice. Either of the following can be used as the semantics of a join-choice (merge) element. In case of single execution, the join-choice element is executed only once following whichever outgoing edge is completed while the other branches are discarded as and when they finish. In multiple executions semantics, whenever any of the incoming branches is completed the join choice element is executed, which may however give rise to multiple instances.

Note that if all the incoming branches of a join-choice are active at the same time, the “multiple executions” semantics may cause correctness problems. There are two typical structural incorrectness/flaws that can take place in processes: deadlocks and lack of synchronization. A BPM process is sound if it does not produce deadlocks and lack of synchronization. A deadlock implies that the process will never terminate. A lack of synchronization allows multiple instances of the same task to occur to occur in a process. Multiple instances can lead to undesirable results, such as redundant activities, competition for resources, and dangling activities (e.g. one instance is synchronized with a task, and then the other instances are left dangling).

Given a BPM process P, an execution path exp can be defined as a sequence of nodes, such that two consecutive nodes belong to the control relation, and exp begins and ends at the unique start and final event respectively. A fragment of an execution path is given by f exp which may not necessarily begin at a start node or end at an end node (execution paths restricted to tasks are considered). A complete/legal trace τ of a BPM process P is a projection of an execution on the set of activities/tasks, only keeping the start node at the beginning, and the end node at the end. An ordinary trace is a fragment of a complete trace, which again projects a fragment of an execution on the set of activities only. The set of all legal traces of a process P is denoted as τₚ.

This definition of a BPM process closely matches with that of a workflow. However, only structured BPM processes are used, which are much like structured workflows. Structured processes can be represented in XML such that split and join control nodes correspond to start and end tags, as is followed in BPEL notation. A BPM process is structured if and only if it can be built inductively as follows:
1. All well-formed linear processes (processes sans control/gateway nodes) are structured.
2. All well-formed processes which have only one XOR-split and only one XOR-join as control nodes are structured.
3. All well-formed processes which have only one AND-split and only one AND-join as control nodes are structured.
4. If P₁ and P₂ are structured processes and P₁ contains an edge e, the result of replacing e with P₂ in P₁ still makes the resulting process structured.

Communicating Sequential Process (CSP):

In Communicating Sequential Process (CSP), a process depicts a kind of behavior, a behavior is made of events which are atomic and asynchronous between the environment (which can be another process) and the process. Processes communicate via events, they can be made compound by using the dot operator “•”. As for notations, assume that √ represents successful termination. Now consider a finite set of events where √ [symbol] Σ. Then assume Σ√ represent Σχ√. Further, a [symbol] Σ, AφΣ and BφΣ√. RφΣ×Σ is a renaming relation on Σ. A simplified syntax of CSP is shown as follows:

$$P :: = STOP \vert SKIP \vert a \to P \vert a \text{:} A \to P ( a ) \vert \\ \vert {P}_{1} □ {P}_{2} \vert {P}_{1}^{′} {P}_{2} \vert {P}_{1} {‖}_{B} {P}_{2} \vert {P}_{1} \vert \vert \vert {P}_{2} \vert {P}_{1} ; {P}_{2} \vert \\ P \backslash A \vert P [ R ] \vert X \vert μ X \cdot P \vert {P}_{1} Δ {P}_{2}$$

The simplest process is STOP; this is a deadlocked process that cannot communicate with its environment. The process SKIP is equivalent to the process √→ STOP, which depicts successful termination followed by deadlock. The next process is called a prefix process represented as a→P. The prefix process offers to engage in the event a and subsequently behaves like process P. The generalized prefix process is represented by a:A→P(a) and it offers to engage in any event a 0 A and subsequently behave like process P(a). The external choice operator written as, P₁ P₂, offers to behave either as P₁ or as P₂ at the choice of the environment. On the other hand, the internal choice operator represented as P₁′P₂ may behave either as P₁ or as P₂ in a nondeterministic fashion. The choice between P₁ and P₂ is resolved independently of the environment. The generalized parallel operator is written as

$${P}_{1} {‖}_{B} {P}_{2}$$

and it is a parallel composition of P₁ and P₂ where P₁ and P₂ have to synchronize on all events in B and behave independently with respect to all other events.

There is an interleaving operator in CSP which means that the processes which are interleaved may behave in an independent manner with respect to all the events except √. Interleaving is represented as P₁ [symbol] P₂. The sequential composition operator is a process written as, P₁; P₂. Initially the process behaves like P₁ until P₁ terminates successfully and then the process starts behaving like P₂ immediately. Some of the events in a CSP process may be hidden so that they do not appear in the observations of the behavior of the process. In the process P\A, the symbol ‘\’ is referred to as the hiding operator. This process behaves like the process P except that in the behavior of P, events in A are hidden. To model non-determinism and hiding adequately one can use a special symbol ε′ to represent invisible events. Renamed processes given by P [R] have the behavior of process P except that the events are renamed depending on the relation R. The process variable X has no behavior of its own, but can behave like any process P. Recursion in CSP is represented by μX.P which is the least solution of the equation X=P. Interrupt is represented by P₁εP₂ which behaves like P₁ but can be interrupted by P₂. We use the notation □a:{x₁, . . . , xₖ} ·P(a) to denote external choice over the processes {P(x₀), P(x₁), . . . , P(xₖ)} and likewise for operators ′, [symbol] .

There are three commonly used semantics of process algebras: denotational semantics, operational semantics, or algebraic semantics. A denotational semantics maps programs into some abstract model such as a structured set or a category and is called the denotation of the program. An important aspect of denotational semantics is that it should be compositional, which means that the denotation of a program should be derivable from the denotation of the parts of the program. The operational semantics model programs as labeled transition systems. This operational semantics captures the possible executions of a program.

A number of denotational semantics models have been proposed for CSP, each of them modeling the observable behavior of CSP processes. There are three models which are used most often, and are supported by FDR model checker (stands for Failures, Divergence, Refinement and is a refinement checker for CSP processes). These models are traces [symbol] , stable failures [symbol] , and failures divergences model ( [symbol] ).

Informally, a trace of a CSP process is a sequence of visible events that the process can perform. The traces model is a set of such traces where the set is non empty and prefix closed. Let the set of traces of process P be called traces (P). A stable state of a CSP program is one from which only visible events can be performed. In the traces model, the processes P₁˜P₂. and P₁ [symbol] P₂. are considered to be equivalent.

The operational semantics considers a CSP process as a labeled transition system where the nodes represent the processes and the labels represent visible or τ events. The semantics of a process is then calculated by applying inference rules. The important thing to note is that the denotational and the operational semantics of CSP have been shown to be a congruence.

For all the models of CSP, refinement relations have been described. An implementation behaves correctly when its behavior meets the behavior of the specification (its denotational semantics defines both what a process can do and what a process must do). When the implementation is indeed correct, the implementation refines the specification. Given an implementation process IMPL and a specification process SPEC, implementation trace refines specification if and only if

[symbol]

IMPL [symbol] traces(IMPL)⊂traces(SPEC)

A framework is introduced for defining process conformance, where given a process log W over a set T of log events, and a reference process model P in BPMN, the question “does the process log conform to the reference BPM process” can be answered. First the process model must be relevant to the process log, i.e., the set of activities in the process model contain the tasks appearing in the process log. Formally, a process log W over a set T of events is relevant to a BPM process P, if the set of activities in T belong to the set of activities in P.

Given a process log W over a set T of log events, and a reference model P, the process log W conforms to process model P (written as W∞_{C}P) if W is relevant to P, and σ is a trace in W implies σ is a trace in P, W⊂τₚ. Similarly, whether a process model P conforms to a process log W (written as P∞_{C}W) can be defined. These problems are known as conformance checking (ConCheck) problem.

To decide the ConCheck problem membership testing problem must be performed. Given an arbitrary process log W and a fixed (reference) BPM model P, a check is made as to whether any trace σ in W is also a trace in P. For a fixed BPM process it is possible to enumerate all possible traces. Since this is a one-time construction and input is an arbitrary trace and a fixed process, the inclusion problem can be decided in time quadratic in the maximum length of traces. However, the number of processes created by a process model may grow exponentially, especially when a process model has AND-gateways and shows concurrent behavior. For example, there are 4!=64 possible ways of executing 5 parallel tasks and 8!=40320 possible combinations for 8 tasks. Thus it may be quite expensive to enumerate all the traces of the model for checking the membership later on. Further, in an industrial scenario, the help of an off-the-shelf tool (model checker) can be needed to settle the conformance checking problem easily and efficiently. This is the reason an intermediate step of converting these models to trace equivalent CSP descriptions is performed such that the conformance checking problem can be reduced to trace refinement problem, and can be solved using FDR model checker.

Structured process models are translated to CSP descriptions (i.e. mapping a BPM process to CSP Processes). A structured BPM process can be segregated into a set of basic workflow patterns. A pattern can consist of simple activity nodes, routing gateways and events. For each of these patterns appropriate CSP processes are generated. Using the flow relation between the patterns, the CSP processes are synchronized in a way that reflects the exact behavior (traces) of the process.

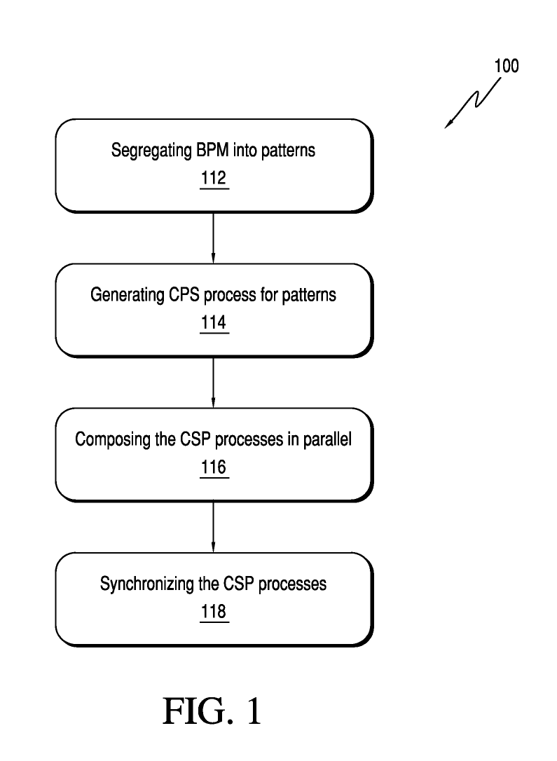

FIG. 1 illustrates a method 100 for mapping a business process model to a CSP process. Each step can be accomplished by one or more computing devices. In step 112, a business process model is segregated into a set of workflow patterns with connectivity between the workflow patterns. In step 114, a CSP process is generated for each workflow pattern. In step 116, the CSP processes are composed in parallel with connectivity between the CSP processes. In step 118, the CSP processes are synchronized on common activities of the CSP processes. An example of this method is discussed in detail below.

Here, X⊂ [symbol] is defined to be a set of activities. Further, {k:X·complete.k} is defined as the set of events which represent the completion of the activities (in consistent with the events being observed for event logs). A basic CSP process SP (a, b) is defined below where both a, b c A.

SP(a,b)=complete.a→complete.b→SKIP

One or more computing devices translate the process model into Communication Sequential Processes (CSP) description blocks using a pattern oriented approach. The method is described in greater detail below.

Basic control flow patterns of BPM processes are translated to corresponding CSP processes, using a pattern oriented approach, where [symbol] denotes the set of activities of process P. BEGIN is a pattern which denotes the start of a BPM workflow model. Assume that activity a is triggered after the event start is performed. This pattern is modelled by CSP process BEGIN(a).

BEGIN(a)=start→SP(a,δ)

END is a pattern which denotes the end of a BPM process. The model can terminate successfully after completion of the final activity a. The event complete.δ is subsequently used to denote a completion of an arbitrary relevant activity δ associated with a process.

END(a)=complete.a→SKIP

Sequence denotes the situation where activities a and b are executed sequentially if after the completion of a, activity b is triggered. This pattern is modeled by CSP process SEQ(S) where S is a non-empty set of activities, e.g., S={a, b}.

$$SEQ ( 〈 〉 ) = SKIP$$

$$SEQ ( 〈 s 〉 ) = SP ( s , δ )$$

$$SEQ ( 〈 s , t 〉 \{ S ) = SP ( s , t ) {‖}_{\{ complete . t \}} SEQ ( 〈 t 〉 ) \{ S )$$

The symbol “{” denotes concatenation for sequence. Process SEQ (+s,t,){S) performs events completes and complete.t sequentially and then synchronizes with process SEQ (+t){S) on the event complete.t.

Parallel Split (AND-split): Assume both the activities b and c are triggered in parallel after the execution of activity a. This pattern is modeled by a CSP process ASP(a, X), where a is an activity and Xφ [symbol] is the set of activities to be triggered after the execution of a. In this case X={b, c}.

$$ASP ( a , X ) = ( a \to ( \vert ‖ k \text{:} X \cdot complete . k ) \to SKIP ) {‖}_{\{ k \text{:} X \cdot complete . k \}} \vert ‖ k \text{:} X \cdot SP ( k , δ )$$

Synchronization (AND-join): Activity a is triggered after the completion of the execution of both the activities b and c. This pattern is modeled by a CSP process AJP (X, a) where a is an activity and Xφ [symbol] is the set of activities to be executed before a is triggered. For this case X={b, c}.

$$AJP ( X , a ) = {‖}_{\{ complete . a \}} k \text{:} X \cdot SP ( k , a ) {‖}_{\{ complete . a \}} SP ( a , δ )$$

Exclusive Choice (XOR-split): After the execution of activity a either of the activities b or c is triggered. The choice between b and c is nondeterministic. This pattern is modeled by a CSP process XS (a, X), where X={b, c}.

$$XS ( a , X ) = let XSP = complete . a \to {}^{′} k \text{:} X \cdot complete . k \to SKIP within XSP ( a , x ) {‖}_{\{ k \text{:} X \cdot complete . k \}} □ k \text{:} X \cdot SP ( k , δ )$$

Exclusive Merge (XOR-merge): Activity a is triggered after completion of either of the activities b or c. The CSP process for XOR-merge is defined as XSJ(X, a), where

$$XSJ ( X , a ) = □ k \text{:} X \cdot SP ( k , a ) {‖}_{\{ complete . a \}} SP ( a , δ )$$

More advanced control flow patterns can also be defined in a similar manner. In fact, inclusive-OR gateways can be modeled using XOR and AND gateways. For example, an inclusive-OR split of activity a into two activities a₁ and a₂ can be modeled with an XOR-split with three outgoing flow containing a₁, a₂ and another flow with AND-join of a₁ and a₂ etc.

For generating the CSP process for the whole BPM process, the model is segregated into the patterns maintaining the connectivity between them. The next step is to generate CSP processes corresponding to each pattern. And finally to capture the behavior of the whole model, all the CSP processes thus generated are composed in parallel maintaining the connectivity between patterns, and synchronizing them on their common activities. This is possible since only structured CSP processes are considered.

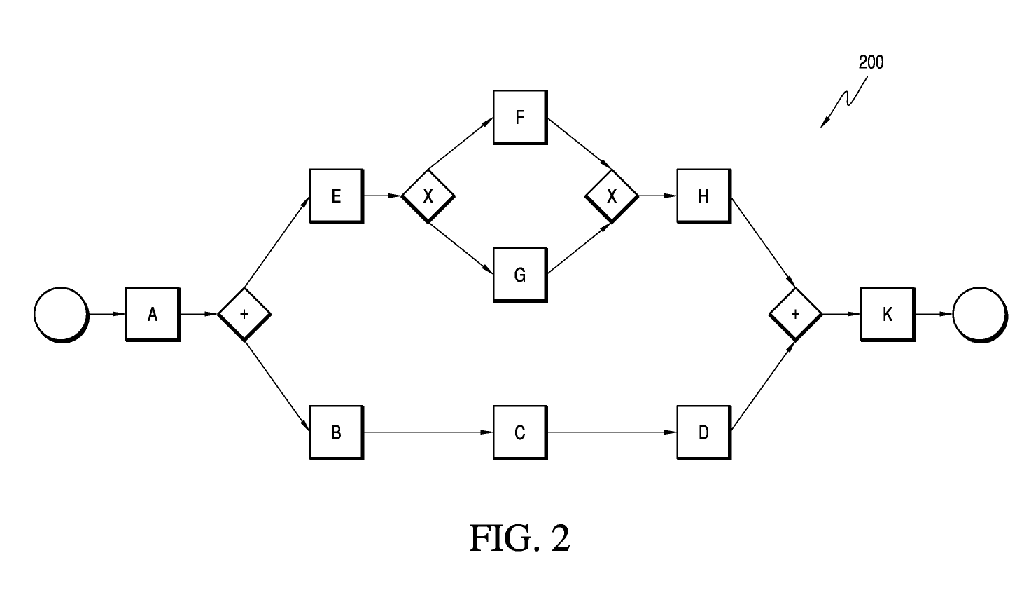

FIG. 2 shows a structured process P 200, which is represented by the following CSP:

$${Q}_{P} = ( BEGIN ( a ) {‖}_{\{ complete . a \}} ASP ( a , \{ b , e \} ) ) {‖}_{\{ complete . b , complete . e \}} ( SEQ ( 〈 b , c , d 〉 ) \vert ‖ XSP ( e , \{ f , g \} ) ) {‖}_{\{ complete . f , complete . g \}} XSJ ( \{ f , g \} , h ) {‖}_{\{ complete . h , complete . d \}} AJP ( \{ h , d \} , k ) {‖}_{\{ complete . k \}} END ( k )$$

As proposition 1, let Q be the CSP process generated from a reference structured BPM process P following the algorithm above. Then Q is trace equivalent to P.

Let η be the depth of the nesting of control nodes for the structured process P. The proof is by taking induction on η.

For the base induction step, let η=0. Then P is a process without control nodes. Assume P to have only one activity a connected to the start node and end node (in a more general case one can consider a sequence of activities between the start and end nodes). Then the CSP description of such a process is given by:

$$Q = Begin ( a ) {‖}_{\{ complete . a \}} END ( a )$$

Consider a complete trace τ (from start node to end node) of Q. Then τ=<start,complete.a,end). Then it is see that σ=start a end is a complete trace of the corresponding process P. A similar argument follows for the other way.

For the induction step, assume the hypothesis is true for η=k. The same is established for η=k+1. It can be done by taking induction on the structure of the process. Here an AND gateway is considered, but the proof can be easily adopted for XOR gateways.

An AND-split is considered to be the outermost split node of the process. Suppose the start node is connected to this split via an activity a. W log assumes that there are two outgoing flows b₁ and b₂ from this split. Let the subprocess beginning with b₁(b₂) have a trace equivalent CSP-representation as Qb₁ (Qb₂). Then the CSP for the whole process P can be given as (where X={b₁,b₂}).

$$Q = Begin ( a ) {‖}_{\{ complete . a \}} ASP ( a , X ) {‖}_{\{ complete . {b}_{1} , complete . {b}_{2} \}} ( {Q}_{{b}_{1}} \vert ‖ {Q}_{{b}_{2}} )$$

A complete trace <start,complete.a, τ_{Qb}_{₁}, τ_{Qb}_{₂}> for Q is considered as one taking the form. By induction hypothesis, a trace σb1 (σb2) in the subprocess of P beginning with activity b1(b2) corresponding to trace τ_{Qb}_{₁}, (τ_{Qb}_{₂}) can be obtained. Hence from τ one can build a complete trace in P as σ=start a σb1 σb2. Similarly one can start with a complete trace in P and build a trace in Q.

An AND-join is considered as the outermost join node of the process. W log, there are two incoming edges on activities b₁ and b₂ to this join. Let the subprocess ending with b₁(b₂) have a trace equivalent CSP-representation as Q_{b}_{₁} (Q_{b}_{₂}): Then the CSP for the whole process P can be given as (where X={b₁,b₂}).

$$Q = ( {Q}_{{b}_{1}} \vert ‖ {Q}_{{b}_{2}} ) {‖}_{\{ complete . {b}_{1} , complete . {b}_{2} \}} ASP ( a , X ) {‖}_{\{ complete . a \}} End ( a )$$

A complete trace τ=<τ_{Q}_{_{b}}1, τ_{Q}_{_{b}}2, complete.a.end > for Q is considered. By induction hypothesis, a trace σb1 (σb2) in the subprocess of P ending with activity b1(b2) corresponding to trace τ_{Q}_{_{b}}1, (τ_{Q}_{_{b}}2) can be obtained. Hence corresponding to τ one can get a complete trace σ=σb1 σb2 a end in process P.

The method described above is based upon a pattern-oriented approach. Structured models contain gateway blocks either independently or in properly nested fashion. For these processes, the model is decomposed into patterns as described earlier and then, one CSP is generated for each of the patterns. The CSP processes are synchronized using the flow relationship of the original process model. The important point to be note is that, at the time of synchronization, all the events on which synchronization is done, should be available. For unstructured processes, the synchronizing events may belong to different gateway blocks which can lead to their unavailability during pattern synchronization.

The CSP description for the event log is generated by constructing one CSP process for each trace in the log set and then aggregating all of them using external choice operators. The CSP for each trace is a simple prefix process as the traces contain only the sequence of activities. The generation of a CSP process from an arbitrary process log is illustrated as follows:

W={ABCDEGHK,ABEDGHK,ABECDFK} for the reference process in FIG. 1. We write a corresponding CSP description of the log as follow.

Q_{W}=start→complete.a→complete.b→complete.c→complete.d→complete.e→complete.g→complete.h→complete.k→SKIP □start→complete.a→complete.b→complete.e→complete.d→complete.g→complete.h→complete.k→SKIP □start→complete.a→complete.b→complete.e→complete.c→complete.d→complete.f→complete.k→SKIP

It is assumed each trace will begin with the start event, although it cannot be observed, which denotes the initialization of the process instance corresponding to the trace. It is easy to see that traces of Q_{W} (modulo the empty trace) coincide with the original traces in W.

Conformance checking and error logs have been implemented in two steps. In one step event logs are taken as input and generate a simple CSP process Q_{W} as discussed above, which is called implementation Imp. In the next step, the reference process P is translated into an appropriate CSP description Qp, called specification Spec, using the technique described above. Both these CSP models are fed into FDR model checker. A determination is made as to whether Impl trace refines Spec, which decides if the process log conforms to the reference process. If it does not, FDR reports the shortest counterexample. FDR tool generates the shortest counterexample: “start→complete.a→complete.b→complete.e→complete.d”, that is the sequence of activities A, B, E, D. Using the shortest counterexample the actual error trace can be found and in fact, all the error traces in W can be found constructively in an optimal fashion.

A list L, which will ultimately contain all the error traces in W, can be maintained. Initially, it is empty. If a counterexample is obtained; it is the shortest trace τ in CSP process Q_{W}. Find out all the traces in W beginning with the ordinary trace σ in process P, which is extracted out of the CSP trace τ. Put all of them in a temporary list J, which is initially empty. For each a in J create a CSP process Q_{σ} as before, and check [symbol] Q_{σ}. The traces σ which fail to trace refine P, are put into list L. Now update the process log W to WN by deleting all the traces from J. Make J empty. Now create a CSP process Q_{W}N corresponding to the traces in WN and continue till the elements in original process log W are exhausted. Using this one can obtain the list of error traces as L={ABEDGHK, ABECDEF} for the process log W above.

Conformance checking can be measured in terms of metrics which can portray how closely the observed sequences follow the business processes. One way to formulate one such metric would be such that it can measure the deviation between the behavior showed by the process model, and the observed behavior. Such a metric is called fitness metric. One useful metric can be the closeness metric which computes the number of traces in the log that can be actually replayed on the business process model. Another metric can be formulated to estimate how far a model can reflect the behavior observed in the log, these are related to appropriateness metric.

FIG. 2 is a case study process 200 for illustrates the usefulness of metrics. The event logs in Tables 2 and 3 demonstrate the instances of log traces. ProBE tool is used here to simulate the process and then compute the metrics.

TABLE 2
Event Log 1

| No. of Instances | Log Traces |
|---|---|
| 589 | ABDCEHFNMOPR |
| 723 | ADBCGKLNMOPR |
| 458 | ABCDEFKLMNOQR |
| 834 | ABCDEKLFNMOPR |

TABLE 3
Event Log 2

| No. of Instances | Log Traces |
|---|---|
| 629 | ABCDEFHMNOPR |
| 382 | ADBCGHMNOPR |
| 165 | ABCDGKMNOPR |
| 217 | ADBCEHNOQR |
| 984 | ADBCGHMNOQR |
| 210 | ABCDFEKLMNOQR |

Fitness Metric: There can be several ways to measure the fit between event logs and process models. One possibility is to replay an error log in the model and somehow reconstruct a complete/legal trace of the process and see how far it deviate from the former. Using a trace τ in list L, as constructed above, the trace segment τ is replayed in the CSP for the reference model using ProBE tool.

As ProBE is an interactive simulation tool, the counter example can be replayed in the reference model just up to the error element and in order to find the actual trace corresponding to the counter example, the replay can be continued along the possible paths shown in the tool. A complete trace τ is constructed from it. This complete trace may not be unique. However, the shortest one is considered here. In formulating the metric, let n be the aggregated number of traces in log file, fᵢ be the frequency of the ith trace in the log, m number of instances observed in the log, be the length of the error trace τᵢ, and lᵢ^{c} be the length of the shortest complete reconstructed from τᵢ. Then the fitness metric is given by,

$$α = \frac{{\sum }_{i = 1}^{m} {f}_{i} ( \vert {l}_{i}^{a} - {l}_{i}^{c} \vert \text{/} {l}_{i}^{a} )}{n}$$

Noting that n=τᵢ₌₁^{m}fᵢ, α can take value between 0 and 1. From Table 3 we can see that event log 1 has a better fit than event log 2, as all the traces in the former can be replayed on the process model.

Closeness Metric: Another interesting metric could be related to the amount of closeness of the event log W to the process model. It should measure how many traces in the log can be replayed on the process model. This can be captured by a simple metric as follows, as it is possible to generate the list of error traces in W. Below fᵢ^{e} denotes the frequency of ith error trace in the log W.

$$β = \frac{n - {\sum }_{i ∈ L}^{ } {f}_{i}^{e}}{n}$$

This closeness metric β can range from 0 to 1. From Table 4 again, all the traces in log 1 are the traces in the process model as well.

Appropriateness Metric: The metric related to appropriateness of the process log can be subjective, and is defined to suit the purpose. The definition of appropriate metric is centered around process flow related ideas. The aim of formulating such a metric is to see how clearly the model reflects the behavior observed in the log. The degree of appropriateness will depend on the behavioral aspects of it, and it is possible to measure appropriateness with respect to the behavior observed in the log. Even if the log fits the model, there might be some behavior present in the model, but has not been observed. In fact, when the model shows too many behavior it becomes less informative in describing the process. A quantitative measure of the possible behavior reflected in the log is determined by the mean number tasks enabled during the log replay using ProBE tool, with the hope that an increase of potential behavior will result in a higher number of transitions being enabled during log replay.

In formulating this metric, let n denote the aggregated number of traces, λ the total number of tasks in the process model, and μᵢ the mean number of tasks enabled during the replay by ProBE. The behavioral appropriateness metric is given by

$$γ = \frac{{\sum }_{i = 1}^{n} {f}_{i} ( {μ}_{i} - 1 )}{( λ - 1 ) n}$$

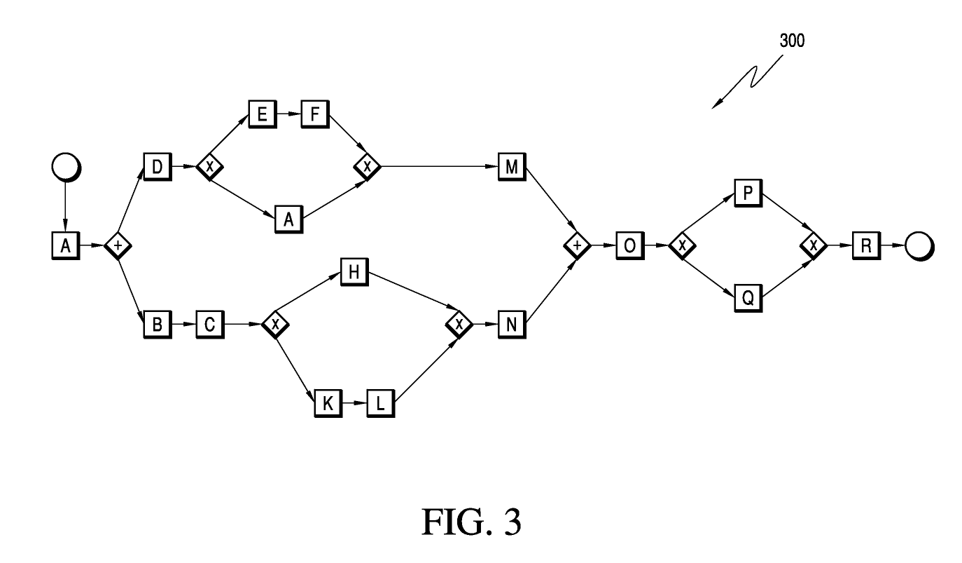

FIG. 3 shows a process model 300, used in demonstrating that even if the event log 1 has better fit and closeness than event log 2, it is behaviorally less appropriate than event log 2.

TABLE 4
Different metric values

| Metrics | Event log 1 | Event Log 2 |
|---|---|---|
| α (fitness) | 1 | 0.8694 |
| β (closeness) | 1 | 0.7711 |
| γ (appropriateness) | 0.0213 | 0.0235 |

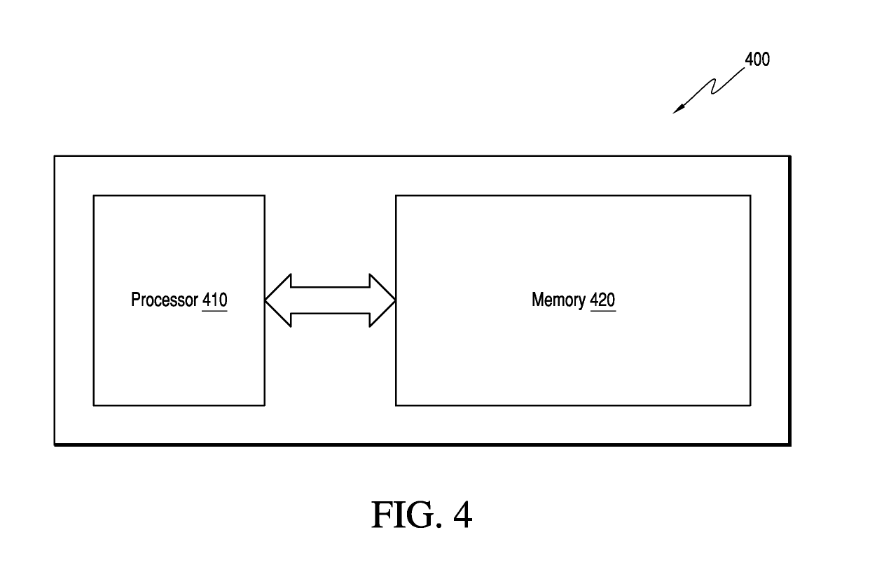

FIG. 4 illustrates a schematic of a computing device 400 that can be used to accomplish the disclosed embodiments. Memory 720 is operatively coupled to processor 410. Processor 710 executes computer readable instructions stored in memory 420 in order to carry out the disclosed methods. Memory 420 can be any type of tangible memory device, such as a magnetic hard disc or an optical disc. computing device 400 can be one or more devices used in combination. For example, computing device 400 can be several computers coupled over a network, such as a LAN or the Internet.

The invention has been described through exemplary embodiments and examples. However, various modifications can be made without departing from the scope of the invention as defined by the appended claims and legal equivalents.

Embodiments have been disclosed herein. However, various modifications can be made without departing from the scope of the embodiments as defined by the appended claims and legal equivalents.

What is claimed is:

1. A method for checking the conformance of observed event logs against a reference business process, the method comprising:
generating a behavioral equivalent CSP process for a structured BPM process; and
creating a CSP description for an arbitrary event log.

2. The method of claim 1, wherein said generating step comprises:
segregating a structured business process model into a set of workflow patterns maintaining the connectivity information between the workflow patterns;
generating a CSP process corresponding to each workflow pattern;
composing the CSP processes in parallel with connectivity between the CSP processes; and
synchronizing the CSP processes on common activities of the CSP processes.

3. The method of claim 2, wherein said synchronizing step comprises synchronizing using the flow relationship of the Business Process Model.

4. The method of claim 2, further comprising the step of receiving an event log of the Business Process Model and wherein said synchronizing step comprises synchronizing based on events of the event log.

5. The method of claim 4, further comprising said creating step comprises creating a CSP description of the event log by constructing a CSP process for each trace in the event log and combining the CSP descriptions using external choice operator.

6. The method of claim 1, further comprising of a methodology of checking the conformance of the process against the logs by checking whether the CSP description for an arbitrary event log trace refines the behavioral equivalent CSP process using FDR model checker.

7. A computing device for checking the conformance of observed event logs against a reference business process, the computing device comprising:
a processor; and
a memory operatively coupled to the processor, the memory storing computer executable instructions which, when executed by the processor, cause the processor to carry out the method comprising:
generating a behavioral equivalent CSP process for a structured BPM process; and
creating a CSP description for an arbitrary event log.

8. The device of claim 7, wherein said generating step comprises: segregating a structured business process model into a set of workflow patterns maintaining the connectivity information between the workflow patterns;
generating a CSP process corresponding to each workflow pattern;
composing the CSP processes in parallel with connectivity between the CSP processes; and
synchronizing the CSP processes on common activities of the CSP processes.

9. The device of claim 7, wherein said synchronizing step comprises synchronizing using the flow relationship of the Business Process Model.

10. The device of claim 8, further comprising the step of receiving an event log of the Business Process Model and wherein said synchronizing step comprises synchronizing based on events of the event log.

11. The device of claim 10, further comprising said creating step comprises creating a CSP description of the event log by constructing a CSP process for each trace in the event log and combining the CSP descriptions using external choice operator.

12. The device of claim 7, further comprising of a methodology of checking the conformance of the process against the logs by checking whether the CSP description for and arbitrary event log trace refines the behavioral equivalent CSP process using FDR model checker.
